(19) United States
(12) Patent Application Publication
(10) Pub. No.: US 2024/0152368 A1
(43) Pub. Date: May 9, 2024

(54) USER INTERFACE MODE CONTROL FOR SUGGESTION REVIEW

(71) Applicant: Microsoft Technology Licensing, LLC, Redmond, WA (US)

(72) Inventors: Peter GROENEWEGEN, Sammamish, WA (US); Rohan Jagdish MALPANI, Everett, WA (US)

(21) Appl. No.: 17/983,644

(22) Filed: Nov. 9, 2022

(51) Int. Cl. G06F 9/451; G06F 3/0484; G06F 40/166

(52) U.S. Cl. CPC G06F 9/453; G06F 3/0484; G06F 40/166

(57) ABSTRACT

Embodiments facilitate human review of autocreated editing suggestions, e.g., suggestions from a machine learning model for editing source code. Upon receiving a suggestion, an editor switches to a user interface review mode displaying an aspect of the suggestion. Suggestions are illustrated using one or more summary, diff, in-place, or as-if views. Upon user command, the editor switches back to the pre-suggestion display, or switches to a different view of the suggestion, or both. In some scenarios, suggestion review of an initially acceptable but ultimately rejected suggestion follows a review-reject sequence instead of an accept-review-undo sequence. In some scenarios, suggestion review visually contrasts pre-suggestion document content with suggested content, by switching display modes on user demand, prior to disposal of the suggestion. In some scenarios, user interface review mode usage is tracked, and modes are prioritized based on their usage.

### BACKGROUND

Many modern devices in a broad range of fields have some form of computing power, and operate according to software instructions that execute using that computing power. A few of the many examples of devices whose behavior depends on software include cars, planes, ships and other vehicles, robotic manufacturing tools and other industrial systems, medical devices, cameras, inventory management and other retail or wholesale systems, smartphones, tablets, servers, workstations and other devices which connect to the Internet.

The firmware, operating systems, applications and other software programs which guide various behaviors of these and many other computing devices is developed by people who may be known as developers, programmers, engineers, or coders, for example, but are referred to collectively here as “developers”. Developers interact with source code editors, compilers, debuggers, profilers and various other software development tools as they develop software.

Professionals in fields other than software development also interact with various editing tools. Word processors, computer aided design tools, or tools for editing video or still image graphics are widely used, for example in science, engineering, education, marketing, finance, politics, journalism, linguistics, and many other fields. Some of the interaction mechanisms in a given editing tool are specific to a single professional field, or even to a single profession. But other interaction mechanisms operate in a variety of editing tools in various ways, spanning multiple professions across different fields.

Although many advances have been made, improvements in human-computer interaction technologies remain possible, and are worth pursuing.

### SUMMARY

Some embodiments described herein address technical challenges related to computer-human interaction, and more particularly challenges related to interactions involving automatically generated editing suggestions. Some editing tools include or communicate with artificial intelligence mechanisms which generate editing suggestions that are presentable to a human user through an editing tool's user interface. Such autocreated suggestions are often helpful, and may save a user effort, e.g., by reducing the number of keystrokes to accomplish a particular edit or by reducing user technical research tasks. However, sometimes the offered suggestion is not acceptable to the user.

Accordingly, a technical challenge is how to optimize the presentation of autocreated suggestions in an editing tool. Subordinate challenges include determining objective criteria to define and measure such optimization, and specifying computer-human interaction mechanisms and interaction sequences that meet the optimization criteria.

Some embodiments described herein facilitate user review of autocreated editing suggestions. Upon receiving such a suggestion, an editing tool embodiment proactively switches from a first user interface mode to a suggestion review user interface mode. Instead of then requiring the user to dispose of the suggestion before continuing the workflow that generated the suggestion, the embodiment allows the user to review the suggestion in one or more suggestion review user interface modes. For example, in response to user commands the editing tool will switch back and forth between displaying the pre-suggestion version of the content that is being edited, and displaying a view that shows what the content would look like if the suggestion were accepted.

In some embodiments, user commands dictate which user interface view is displayed, as well as dictating when the view is displayed. Notably, the acceptance of a suggestion is not a precondition to full review of the suggestion. After the review, a suggestion deemed unacceptable is rejected (per a rejection command) without any change made to the document which is being edited. Thus, these embodiments provide a review-reject sequence to preserve the document's content instead of imposing an accept-review-undo sequence.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including aspects generally suitable for systems which support autocreated suggestion review;

FIG. 2 is a block diagram illustrating an enhanced system configured with autocreated suggestion review functionality;

FIG. 3 is a block diagram illustrating some aspects of some autocreated suggestions;

FIG. 4 is a block diagram illustrating some examples of editing tools;

FIG. 5 is a flowchart illustrating steps in some editing methods, with particular attention to autocreated suggestion review;

FIG. 6 is a flowchart further illustrating steps in editing methods, incorporating FIGS. 5, 16, and 17;

FIG. 7 is a stylized display diagram illustrating an editing tool display in a state denoted D0;

FIG. 8 is a stylized display diagram illustrating the editing tool display in a state denoted D1;

FIG. 9 is a stylized display diagram illustrating the editing tool display in a state denoted D2;

FIG. 10 is a stylized display diagram illustrating the editing tool display in a state denoted D3;

FIG. 11 is a stylized display diagram illustrating the editing tool display in a state denoted D4;

FIG. 12 is a stylized display diagram illustrating the editing tool display in a state denoted D5;

FIG. 13 is a stylized display diagram illustrating the editing tool display in a state denoted D6;

FIG. 14 is a stylized display diagram illustrating the editing tool display in a state denoted D7;

FIG. 15 is a state flow diagram illustrating state changes of the editing tool in the absence of any pre-disposition switch from a tool suggestion review state C to a tool state having display state D1;

FIG. 16 is a state flow diagram illustrating state changes of the editing tool in the presence of a pre-disposition switch (toggle) from the tool suggestion review state C to a tool state F having display state D1; and

FIG. 17 is a state flow diagram illustrating state changes of the editing tool in the presence of a pre-disposition switch from the tool suggestion review state C to a tool state F having display state D1 or a tool state G having another review display state D2, D3, D4, D5, or D6.

### DETAILED DESCRIPTION

Overview

Innovations may expand beyond their origins, but understanding an innovation's origins can help one more fully appreciate the innovation. In the present case, some teachings described herein were motivated by technical challenges arising from ongoing efforts by Microsoft innovators to help software developers edit source code.

Microsoft innovators noted that some source code editing tools include or communicate with artificial intelligence (AI) mechanisms, such as machine learning models, code synthesizers, or code transform generators. These AI mechanisms generate editing suggestions that are presented to a human user through an editing tool's user interface. For example, a tool may suggest a code refactoring, a repetition of previously made edits in a new context, changes to make identifiers in a pasted piece of code conform with the surrounding code to permit successful compilation, ways to complete an identifier or a line of code or a block of code, and so on.

Such autocreated suggestions are often helpful, and they often save a developer time and effort. Some generated suggestions reduce the number of keystrokes required to accomplish a particular edit, one key press or one mouse click to accept a suggestion replaces dozens or even hundreds of keystrokes. Some suggestions reduce developer technical research burdens. For instance, accepting a regular expression suggestion that was automatically generated from a few examples allows a developer to avoid researching the intricacies of regular expression syntax and semantics.

However, sometimes the offered suggestion is not acceptable to the user. Accordingly, an editing tool that will offer autocreated suggestions to users poses the technical challenge of how to present those autocreated editing suggestions to the users. Meeting this challenge was initially motivated in the context of source code editing, but the challenge also arises in any editing tool that presents automatically generated editing suggestions. The teachings herein may be applied in various kinds of editing tools, including source code editors (standalone or within integrated development environments), word processors for editing natural language documents, computer aided design tools for editing technical and engineering drawings or models, and graphics editors for editing still images, photographs, video, animation, or computer-generated images.

Closely related technical challenges include determining how to optimize the presentation of autocreated suggestions in an editing tool, determining objective criteria to define and measure such optimization, and specifying computer-human interaction mechanisms and interaction sequences that meet the optimization criteria. Teachings herein address each of these challenges.

One optimization criterion defined by the innovators is that a user of an editing tool is able to review an autocreated suggestion in as much depth as the user wants, and for as long as the user wants. However, a brief review should also be possible. Another optimization criterion defined by the innovators is that rejection of a suggestion always leaves intact the document that is being edited. In other words, the suggestion can be reviewed and rejected without any risk that some portion of the suggestion will nonetheless be adopted into the document. These criteria are priorities, but they do not rule out other criteria for autocreated suggestion review mechanisms and operational sequences.

Some embodiments described herein facilitate optimized user review of autocreated editing suggestions. Upon receiving such a suggestion, an editing tool embodiment proactively switches from a first user interface mode to a suggestion review user interface mode. One approach to suggestion review would then require the user to dispose of the suggestion before continuing the workflow that generated the suggestion. For example, the only recognized responses to a suggestion might be accept, reject, or ignore.

This approach is contrary to the optimization criterion of allowing the user to review the suggestion in as much depth as the user wants, and for as long as the user wants. In particular, limiting responses to those that dispose of the suggestion prevents the user from easily comparing the pre-suggestion version of the document with the version shown in the suggestion—the pre-suggestion version is hidden from user view when the suggestion is displayed.

Moreover, in some situations the description of changes shown in the suggestion does not fully convey to a given user the changes that will be made if the suggestion is accepted. Limiting responses to suggestion disposal responses prevents the limited system from displaying other descriptions of suggested changes which more effectively convey the potential impact of suggestion disposal. It may be asserted that the user can simply accept the suggestion, review the changed document, and then enter an undo command if any of the changes are unwanted. But this assertion presumes a perfect undo functionality, and also presumes that all of the changes will be readily evident to the user after they are made. Thus, the accept-review-undo sequence risks a violation of the optimization criterion that rejection of a suggestion always leaves intact the document that is being edited.

Some embodiments provide a better approach, which allows the user to review the suggestion in one or more suggestion review user interface modes. For example, some editing tool embodiments switch back and forth on demand between displaying the pre-suggestion version of the content that is being edited, and displaying a view that shows what the content would look like if the editing suggestion were accepted. Some editing tool embodiments switch on demand between different suggestion views, thus conveying the suggestion and its potential impact more fully. Some embodiments do both, by switching on user command between the pre-suggestion version of the content and two or more versions of the suggestion.

Accordingly, in some embodiments, user commands determine which user interface view of a suggestion is displayed, as well as determining when each view is displayed. Notably, in some embodiments the acceptance of a suggestion is not a precondition to full review of the suggestion. After the review, a suggestion deemed unacceptable is rejected (per a rejection command) without making any change to the document that is being edited. These embodiments provide a review-reject sequence to preserve the document's content instead of imposing an accept-review-undo sequence. The accept-review-undo sequence does not build user confidence in generated suggestions 214. Without a visible preview of changes which is subject to the user's review of whichever details at whatever level of detail and for however long the user prefers, users will tend to avoid accepting suggestions 214. An undo ability not optimal, because without the option of full review as taught herein, the user will not be confident of whether the undo is needed to achieve desired changes in the content 212.

Some embodiments taught herein receive in a first user interface mode an autocreated editing suggestion, then in response to the receiving, switch from the first user interface mode to a second user interface mode which displays the suggestion, in the second user interface mode get a mode switch user command, and in response to the getting, switch from the second user interface mode to at least one of the first user interface mode or a third user interface mode. The user interface modes each differ from one another visually in at least one of the following ways: a display of the suggestion, or a display of an editing result that will follow from an acceptance of the suggestion. During the sequence the editing tool does not do any of the following to dispose of the suggestion: accept the suggestion, reject the suggestion, dismiss the suggestion, or get an undo user command. A benefit provided by these embodiments is that fuller review of the suggestion by the user is possible because the suggestion can be easily compared to the pre-suggestion content without first accepting the suggestion. Another benefit of some of these embodiments is that different views of the suggestion are provided, allowing fuller review of the suggestion by the user without first accepting the suggestion.

In some embodiments, the second user interface mode displays at least one of the following: a side-by-side diff view illustrating the suggestion, an over-under diff view illustrating the suggestion, an in-place diff view illustrating the suggestion, or an in-place as-if view illustrating the suggestion. A benefit of these embodiments is that different views of the suggestion are provided, allowing fuller review of the suggestion by the user without disposing of the suggestion.

Some embodiments track respective usage of at least the second user interface mode and the third user interface mode, and prioritize presentation of whichever user interface mode has greater usage. A technical benefit of these embodiments is that suggestion views which are favored by a given user will tend to be presented more, over time, than the less favored views, thereby facilitating review of autocreated suggestions in a manner favored by the user.

These and other benefits will be apparent to one of skill from the teachings provided herein.

Operating Environments

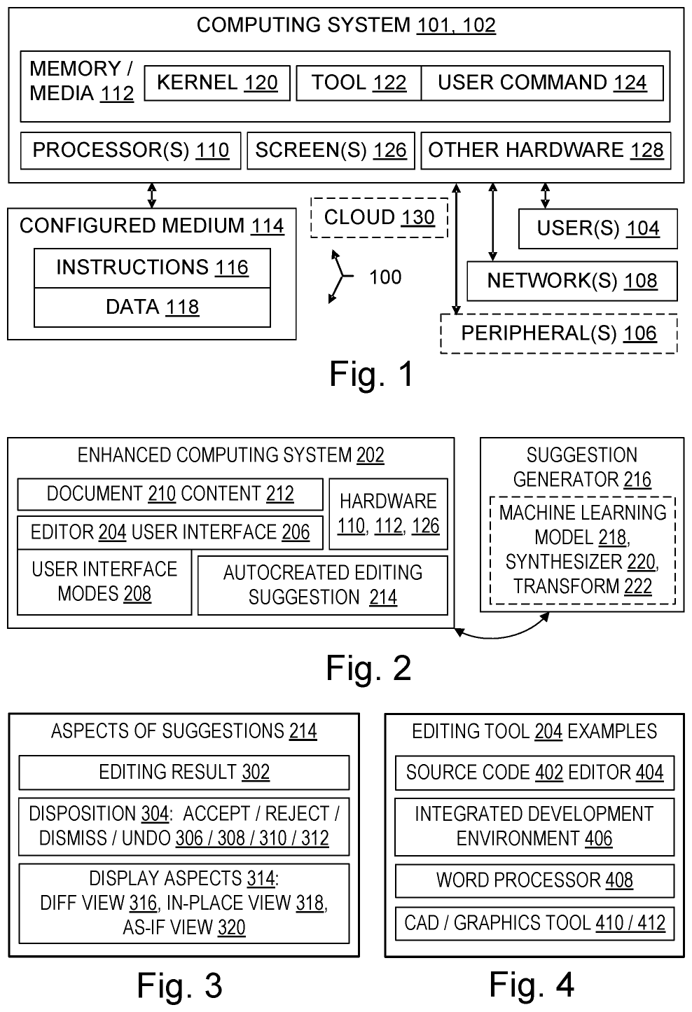

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 130. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface 206 by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface 206 supports interaction between an embodiment and one or more human users. In some embodiments, the user interface 206 includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services, such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 130 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software apps, on mobile devices 102 or workstations 102 or servers 102, as well as APIs, browsers, or webpages and the corresponding software for protocols such as HTTPS, for example. Files, APIs, endpoints, and other resources may be accessed by an account or set of accounts, user 104 or group of users 104, IP address or group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside, when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, autocreated suggestion review functionality could be installed on an air gapped network and then be updated periodically or on occasion using removable media 114, or not updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience, inclusion of an item in FIG. 1 does not imply that the item, or the described use of the item, was known prior to the current innovations.

In any later application that claims priority to the current application, reference numerals may be added to designate items disclosed in the current application. Such items may include, e.g., software, hardware, steps, methods, systems, functionalities, mechanisms, data structures, resources, entities, or other items in a computing environment, which are disclosed herein but not associated with a particular reference numeral herein. Corresponding drawings may also be added.

More About Systems

FIG. 2 illustrates a computing system 102 configured by one or more of the autocreated suggestion review enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 shows some aspects of autocreated suggestions 214. This is not a comprehensive summary of all aspects of automatic suggestion generation or all aspects of autocreated suggestion review functionality or of suggestion 214 review. Nor is it a comprehensive summary of all aspects of an environment 100 or system 202 or other context of suggestions 214, or a comprehensive summary of all editing mechanisms 204 for potential use in or with a system 102. FIG. 3 items are discussed at various points herein, and additional details regarding them are provided in the discussion of a List of Reference Numerals later in this disclosure document.

FIG. 4 illustrates some examples of editing tools 204. FIG. 4 is not a comprehensive summary of all editing tools 204. FIG. 4 items are discussed at various points herein, and additional details regarding them are provided in the discussion of a List of Reference Numerals later in this disclosure document.

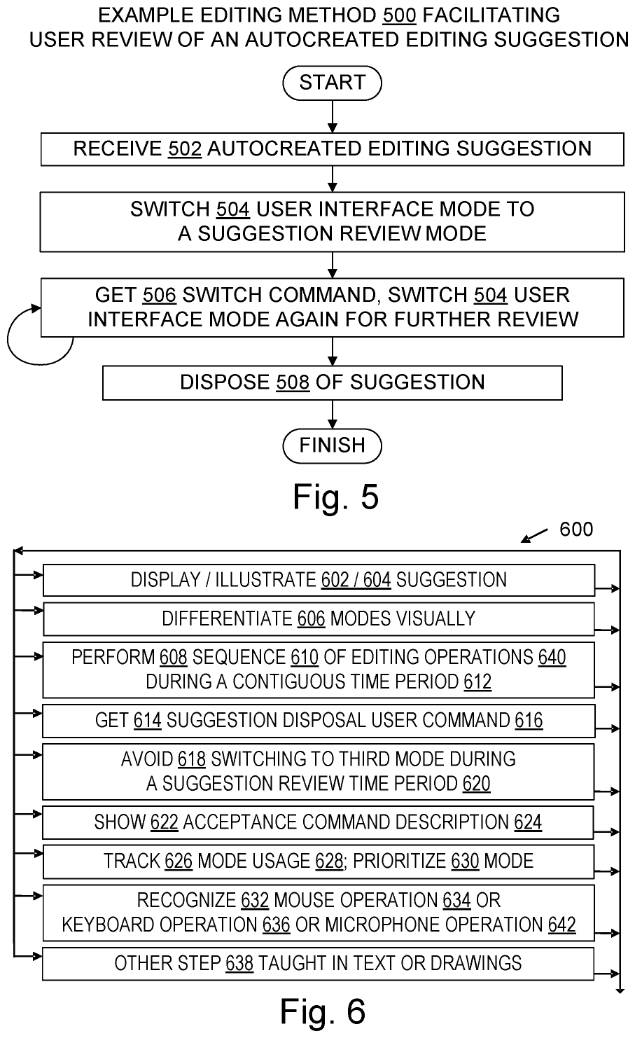

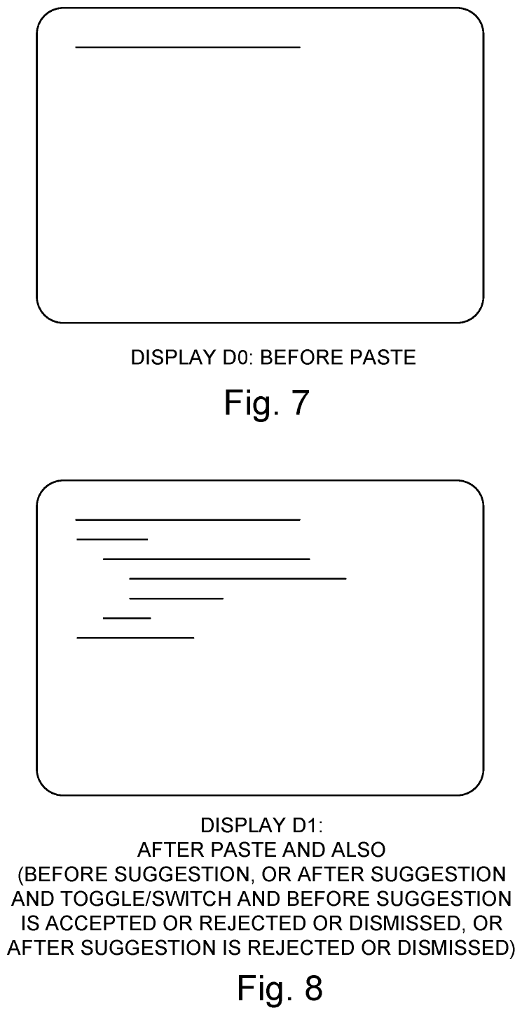

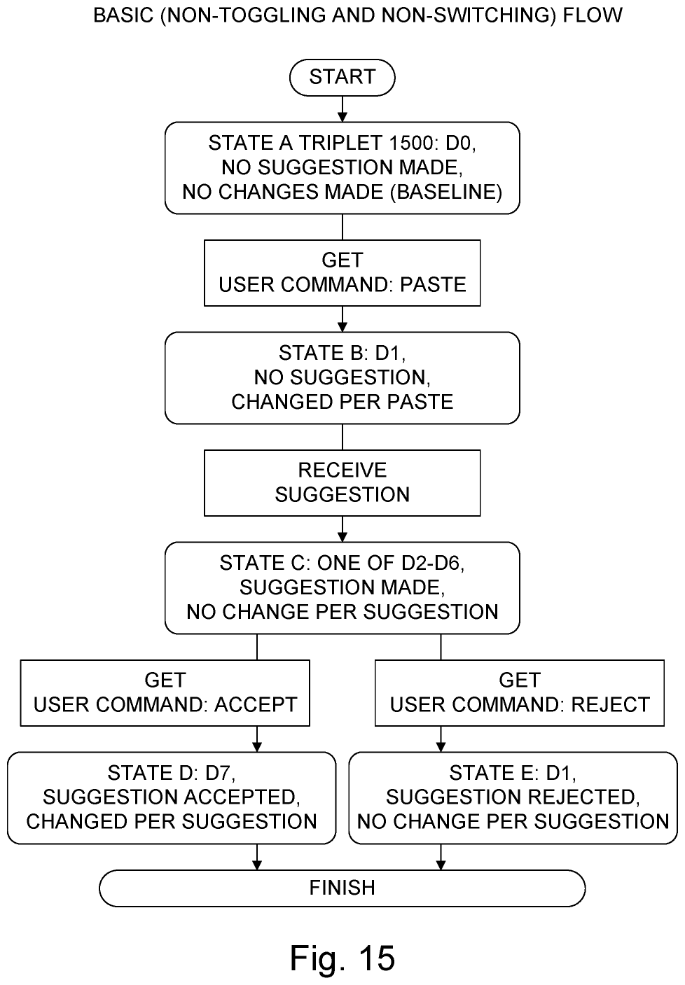

The other figures are also relevant to systems. FIG. 1 illustrates some system hardware and environmental context. FIGS. 5 and 6 illustrate methods of system operation, FIGS. 7 through 14 illustrate system displays 126, and FIGS. 15 to 17 illustrate system state changes.

In some embodiments, the enhanced system 202 is networked through an interface. In some, an interface includes hardware such as network interface cards, software such as network stacks, APIs, or sockets, combination items such as network connections, or a combination thereof.

In some embodiments, a computing system 202 includes: a digital memory 112 and a processor 110 in operable communication with the digital memory, and an editing tool 204 having a user interface 206. The editing tool is configured to perform a sequence 610 of editing operations 640 upon execution by the processor 110. The sequence includes: receiving 502 in a first user interface mode 208 an autocreated editing suggestion 214, in response to the receiving, switching 504 from the first user interface mode 208 to a second user interface mode 208 which displays 602 the suggestion 214, in the second user interface mode 208 getting 506 a mode switch user command 124, and in response to the getting 506, switching 504 from the second user interface mode 208 to at least one of the first user interface mode 208 or a third user interface mode 208. In some embodiments, the user interface modes 208 each differ 606 from one another visually in at least one of the following ways: a display 602 of the suggestion 214, or a display 602 of an editing result 302 that will follow from an acceptance 306 of the suggestion. In some embodiments, during the sequence 610 the editing tool does not do any of the following: accept 306 the suggestion, reject 308 the suggestion, dismiss 310 the suggestion (e.g., by moving an edit cursor outside a current block, by pressing an Escape key, or clicking a close icon), or get 614 an undo 312 user command 124.

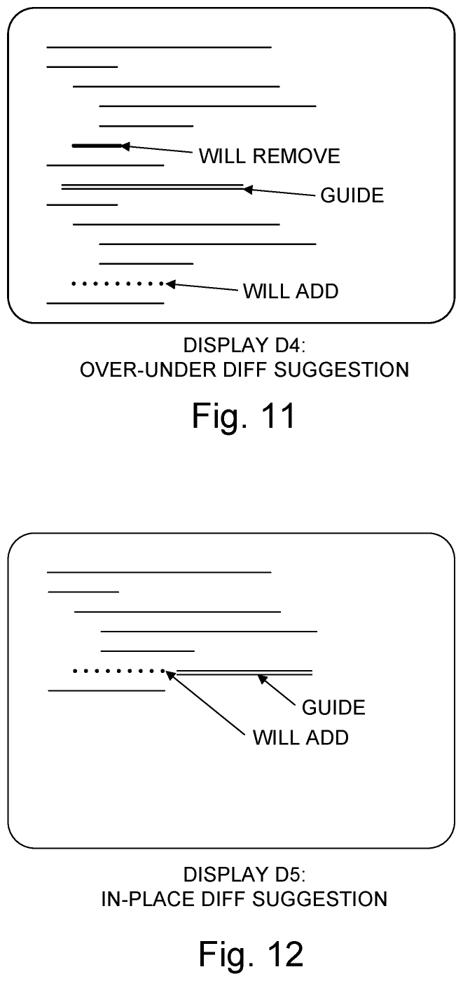

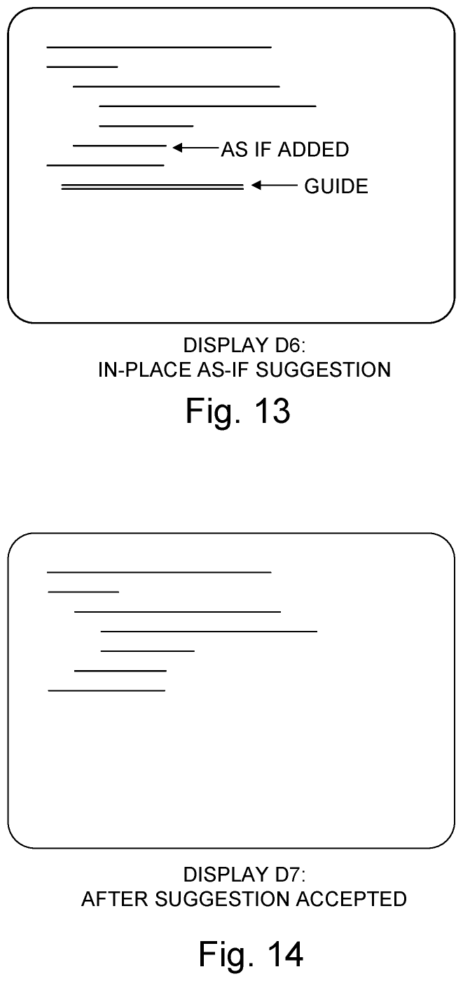

In some embodiments, the second user interface mode 208 displays 602 at least one of the following: a side-by-side diff view 316 illustrating 604 the suggestion (e.g., per FIG. 10), an over-under diff 316 view illustrating 604 the suggestion (e.g., per FIG. 11), an in-place diff view 316, 318 illustrating 604 the suggestion (e.g., per FIG. 12), or an in-place as-if view 318, 320 illustrating 604 the suggestion (e.g., per FIG. 13).

In some embodiments, the sequence 610 includes switching 504 to the third user interface mode 208 in response to getting 506 the mode switch user command 124. For example, in some embodiments one such sequence 610 would include displays D1, D3, D5 shown in the Figures. Another such sequence 610 would include displays D1, D2, D3 shown in the Figures. More generally, in some embodiments such a sequence 610 would include display D1 as the first user interface mode, followed by any one of the displays D2 through D6 as the second user interface mode, followed by any other of the displays D2 through D6 as the third user interface mode.

In some embodiments, the editing tool 204 includes at least one of the following: a source code editing tool 404, an integrated development environment 406, a word processor 408, a computer aided design tool 410, or a graphics editor 412.

Other system embodiments are also described herein, either directly or derivable as system versions of described processes or configured media, duly informed by the extensive discussion herein of computing hardware.

Although specific autocreated suggestion review architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of autocreated suggestion review functionality, for example, as well as different technical features, aspects, mechanisms, rules, criteria, expressions, hierarchies, operational sequences, data structures, environment or system characteristics, or other functionality consistent with teachings provided herein, and may otherwise depart from the particular examples provided.

Processes (a.k.a. Methods)

Methods (which are also be referred to as “processes” in the legal sense of that word) are illustrated in various ways herein, both in text and in drawing figures. FIGS. 5 and 6 each illustrate a family of methods 500 and 600 respectively, which are performed or assisted by some enhanced systems, such as some systems 202 or another autocreated suggestion review system as taught herein. Method family 500 is a proper subset of method family 600.

FIGS. 15 to 17 also show state changes associated with method steps such as receiving 502 an autocreated suggestion, switching 504 to a suggestion review mode (as opposed to the first user interface mode), getting 506 a user command, or switching 504 display modes. FIGS. 7 through 14 show displays at various points in an autocreated suggestion review method, as noted in the Figure annotations and the discussion of displays D0 through D7, for example. FIGS. 1 through 4 show autocreated suggestion review architectures with implicit or explicit actions, e.g., receiving 502 an autocreated suggestion, displaying 602 a suggestion per a user interface mode 208, or otherwise processing data 118, in which the data 118 include, e.g., data representing document content 212 and suggestions 214 for editing that content, among other examples disclosed herein.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types in a value for the system 202 to use as a file name for a document 210. But no process contemplated as innovative herein is entirely manual or purely mental, none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 6. FIG. 6 is a supplement to the textual examples of embodiments provided herein and the textual descriptions of embodiments provided herein. In the event of any alleged inconsistency, lack of clarity, or excessive breadth due to an aspect or interpretation of FIG. 6, the text of this disclosure shall prevail over that aspect or interpretation of FIG. 6.

Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 600 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 10 to be non-operable, the sequence S is not within the scope of any claim. Any assertion otherwise is contrary to the present disclosure.

Some embodiments provide or utilize an editing method performed by an editing tool 204 in a computing system 202, the method including: receiving 502 in a first user interface mode an autocreated editing suggestion, without displaying the suggestion in the first user interface mode; in response to the receiving, switching 504 from the first user interface mode to a second user interface mode which displays the suggestion; in the second user interface mode, getting 506 a mode switch user command; in response to the getting, switching 504 from the second user interface mode to at least one of the first user interface mode or a third user interface mode. The user interface modes each differ 606 from one another visually in at least one of the following ways: a display of the suggestion, or a display of an editing result that will follow from an acceptance of the suggestion. During a contiguous time period 612 that encompasses the switching from the first user interface mode to the second user interface mode, the getting the mode switch user command, and the switching to at least one of the first user interface mode or a third user interface mode, the editing tool does not dispose 508 of the suggestion by doing any of the following: accept the suggestion, reject the suggestion, dismiss the suggestion, or get an undo user command.

In some embodiments, the method includes the following after receiving 502 the suggestion in the first user interface mode and before disposing 508 of the suggestion: switching 504 at least twice to the first user interface mode from at least one other user interface mode in response to getting 506 a respective mode switch user command.

In some embodiments, the method includes the following after receiving 502 the suggestion in the first user interface mode and before disposing 508 of the suggestion: switching 504 between at least three user interface modes 208 in response to getting 506 a respective mode switch user command.

In some embodiments, the second user interface mode displays 602 a diff view illustrating the suggestion. FIGS. 10, 11, and 12 show example diff views 316.

In some embodiments, the second user interface mode displays 602 an in-place view illustrating the suggestion. FIGS. 12 and 13 show example in-place views 318.

In some embodiments, the second user interface mode displays 602 an as-if view illustrating the suggestion. FIG. 13 shows an example as-if view 320.

In some embodiments, displaying 602 the suggestion includes showing 622 a human-readable description 624 of a suggestion acceptance user command 124. For example, the description 624 may recite “space to accept” or “Tab to accept” or “tab to adjust variable names in pasted text to context” or show similar acceptance guidance.

In some embodiments, the method avoids 618 switching 504 to any third user interface mode during a review time period 620 which begins with the contiguous time period 612 and ends with getting a suggestion disposal 508 user command 124.

In some embodiments, the method includes getting 506, 614 a suggestion disposal user command 124 and in response disposing 508 of the suggestion 214. Examples of disposal frequently encountered would include acceptance 306, rejection 308, dismissal (e.g., by pressing Escape to return to the pre-suggestion display), or undo 312. Infrequent examples would include the editor 204 crashing, the user abandoning the system 202, or a system hardware failure. The result in each disposal 508 is that the suggestion 214 is no longer pending.

In some embodiments, the second user interface mode displays 602 the suggestion, and the suggestion includes a source code 402 editing 640 suggestion 214.

In some embodiments, the method includes tracking 626 respective usage 628 of at least the second user interface mode 208 and the third user interface mode 208, and prioritizing 630 presentation of whichever user interface mode 208 has greater usage. For example, tracking may show a pattern of switching from display D3 to D5 and from D4 to D5 within five seconds or less and then remaining in D5 for at least twenty seconds. In response, the system may prioritize 630 the mode 208 associated with D5 so that anytime D3 or D4 would be shown, D5 is shown instead. In a variation, the initial review mode 208 is specified by the user, e.g., by a preference setting or other user command 124.

Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as autocreated suggestions 214, diff views 316, in-place views 318, as-if-views 320, acceptance command descriptions 624, usage tracking 626 data structures, mode 208 priority lists 603, and data configuring displays D1 through D7, in the form of data 118 and instructions 116, read from a removable storage medium 114 and/or another source such as a network connection, to form a configured storage medium. The configured storage medium 112 is capable of causing a computer system 202 to perform technical process steps for autocreated suggestion review, as disclosed herein. The Figures thus help illustrate configured storage media embodiments and process (a.k.a. method) embodiments, as well as system and process embodiments. In particular, any of the process steps illustrated in FIG. 5, 6, 15, 16, or 17, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system to perform an editing method, the method performed by an editing tool in a computing system. This method includes: receiving 502 in a first user interface mode an autocreated editing suggestion, without displaying the suggestion in the first user interface mode; in response to the receiving, switching 504 from the first user interface mode to a second user interface mode which displays the suggestion; in the second user interface mode, getting 506 a mode switch user command; in response to the getting, switching 504 from the second user interface mode to another user interface mode; then getting 506 another mode switch user command, and in response to the getting, again switching 504 user interface mode. In some embodiments, the user interface modes each differ from one another visually in at least one of the following ways: a display of the suggestion, or a display of an editing result that will follow from an acceptance of the suggestion. In some embodiments, during a contiguous time period that encompasses each switching and each getting, the editing tool does not dispose 508 of the suggestion by doing any of the following: accept the suggestion, reject the suggestion, dismiss the suggestion, or get an undo user command.

In some embodiments, getting 506 a mode switch user command includes recognizing 632 a result of at least one of: a mouse operation 634, a keyboard operation 636, or a microphone operation 642.

In some embodiments, receiving 502 the autocreated editing suggestion includes receiving at least one of: a code synthesizer 220 output 214, a machine learning model 218 output 214, or a code transform generator 222 output 214.

In some embodiments, the method includes the following after receiving 502 the suggestion in the first user interface mode and before disposing 508 of the suggestion: switching 504 at least three times to the first user interface mode from at least one other user interface mode in response to getting 506 a respective mode switch user command.

In some embodiments, the user interface modes each differ 606 from one another visually in the display of the editing result that will follow from the acceptance of the suggestion. For example, diff views 316, in-place views 318, and as-if views 320 each differ in this way from the other two: a diff view 316 shows what accepting the suggestion will remove and shows separately what it will add, an in-place view 318 shows the result of the removal and addition superimposed but highlighted, and an as-if view 320 shows what the edited content would look like if the suggestion is accepted, without any highlighting or other visual indications of specific changes other than the actual modifications.

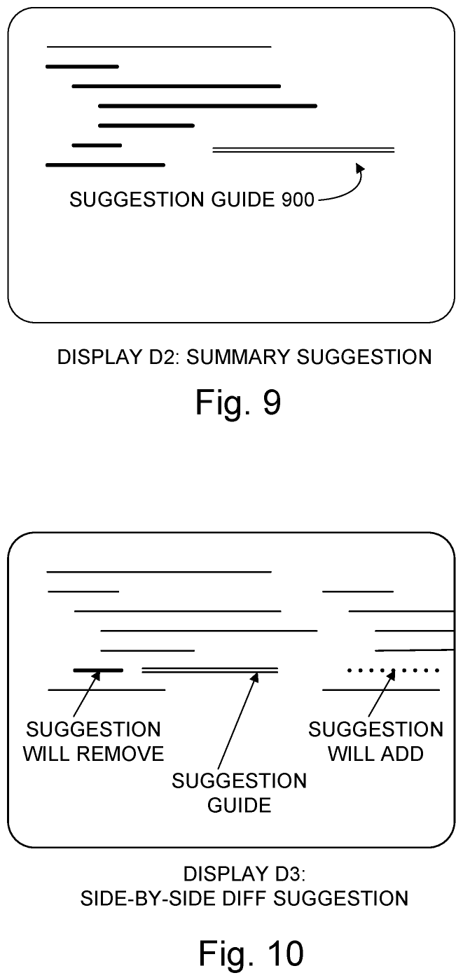

In some embodiments, the user interface modes each differ 606 from one another visually in the display of the suggestion. For example, a summary suggestion like display D2 in FIG. 9 shows the suggestion in less detail than the diff view displays D3 and D4 in FIGS. 10 and 11. That is, some modes 208 display a suggestion in terms of underlying actions such as addition or removal of specific content, whereas other modes 208 omit that level of detail.

Additional Observations

Additional support for the discussion of autocreated suggestion review functionality herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

Some embodiments toggle review styles inline for better reviews. This may be characterized as a user interface (UI) pattern, or a human-computer interaction (HCl) technology, for example. When a system shows a proposed change to a document, the system's user generally wants to be able to review that change. A goal may be to show the change with a minimal UI to avoid interfering with user's editing flow.

However, a minimal UI makes it hard to review suggested changes 214 in some cases. In some embodiments taught herein, a user can switch between the minimal UI and another review UI easily, e.g., in line with a key combination. This supports use of a minimal UI with an option for the user to review the changes before the changes are actually committed to the document 210. This review mechanism helps build trust in the suggested changes (and by extension, user trust in the AI source 216 of those changes) before the actual commit takes place. Reducing a user's cognitive load by showing a minimal UI gets the user's interest, and allows a more intrusive UI to give all the details for review. Switching between the review presentations 208 gives the user a better review experience.

FIGS. 7 to 14 illustrate some example user interface displays 126 as configured in some user experience scenarios. Text 212 is represented by line segments. All the scenarios start with display D0, which for clarity and simplicity in these scenarios shows a single line of text. D0 is followed by display D1, in which the user has pasted in six additional lines of text (that is, the system has pasted in six additional lines of text in response to a user paste command 124).

In the example scenarios, an AI-based suggestion generator 216 generates an editing suggestion 214 in response to the user's paste command. In other scenarios, the suggestion generator 216 may generate an editing suggestion 214 in response to other user commands 124, including find-replace, refactor, or even simple typing.

State flow diagrams referencing the displays D0 through D7 are shown in FIGS. 15 to 17. These state flow diagrams define scenarios, including example scenarios discussed herein. Each state in the flow diagrams represents a triplet (3-vector) 1500 of state information, answering these three questions:
What is displayed to the user in an editing tool user interface 206?
What is the status of an editing suggestion 214 from the AI-based suggestion generator 216?
What is the content 212 of the file that is open for editing in the editing tool 204?

For example, in a state corresponding to display D0 (FIG. 7), a single line of text is displayed, the suggestion 214 has not yet been made, and the file content 212 matches the displayed content 212.

In a state corresponding to display D1 (FIG. 8), the original line of text and the pasted text are displayed, and the suggestion 214 has not yet been made (or at least not yet received 502, but for present purposes suggestion “made” means suggestion received 502). The file content matches the displayed content because the paste modified the file. More generally, a user command 124 that changes displayed content is assumed here to also modify file content but a suggestion 214 will modify file content only if the suggestion is accepted.

FIGS. 9 to 13 illustrate some suggestion review modes 208.

Display D2 (FIG. 9) shows a summary mode 208 for suggestion review. In the summary mode, a region or scope of possible change if the suggestion is accepted is highlighted, but specific changes are not shown. A suggestion guide 900 is also shown. The suggestion guide tells a user what the suggestion will do, and includes an acceptance command description 624 describing how to accept (or reject) the suggestion. For instance, a suggestion guide might say something like “Press TAB to conform identifiers to the local context”.

As for the state information triplet 1500, in FIG. 9 the display D2 shows the original single line of text, the pasted text highlighted (e.g., by bold, background color change, foreground color change, etc.), and the suggestion guide. The suggestion 214 has been made and received 502 and is pending (e.g., not yet accepted, not yet rejected, not yet dismissed by cursor movement elsewhere). That is, the suggestion 214 has not been disposed of 508. The file content matches the displayed content, except that the on-screen highlighting and the suggestion guide are not part of the file content.

Display D3 (FIG. 10) shows a side-by-side diff mode 208 for suggestion review. In the side-by-side diff mode, specific text or other content 212 that will be removed by accepting the suggestion and specific text or other content 212 that will be added in response to receipt of a command accepting the suggestion are visually indicated.

As for the state information triplet 1500, in FIG. 10 the display shows the original single line of text and the pasted text and a copy of the pasted text, and also shows the specific text changes that will be made in response to receipt of a command accepting the suggestion. The suggestion 214 is pending. The file content includes the original single line of text and the pasted text. File content does not include the copy of the pasted text or the suggestion guide or the visual indication that text will be removed.

Display D4 (FIG. 11) shows an over-under diff mode 208 for suggestion review. This is similar to D3, except for positioning within the display.

Display D5 (FIG. 12) shows an in-place diff mode 208 for suggestion review. Instead of showing the text to be added in a separate copy, as in D4 and D3, D5 shows the text to be added as a visually indicated overwrite of the pasted text.

Display D6 (FIG. 13) shows an in-place as-if mode 208 for suggestion review. This shows what the file content would look like if the suggestion 214 is accepted, without any highlighting or other visual indications of specific changes other than the actual text (or other content 212) modifications. However, the file content is still the D2 file content in which no change has been made per the suggestion.

As to the highlighting of changes, or lack of highlighting, some users may prefer that specific details be provided in a suggestion 214. But if a suggestion is the third in a sequence of similar suggestions, for example, or if the changes are merely cosmetic such as reformatting, for example, then some embodiments present the suggestion without cluttering the screen with such details. The change details are suppressed from view, on the assumption that the user already knows the details or deems them unimportant, or both.

Display D7 (FIG. 14) is not a suggestion review mode 208 illustration, because in this display the suggestion 214 has been accepted 306, 508. The displayed content matches the file content.

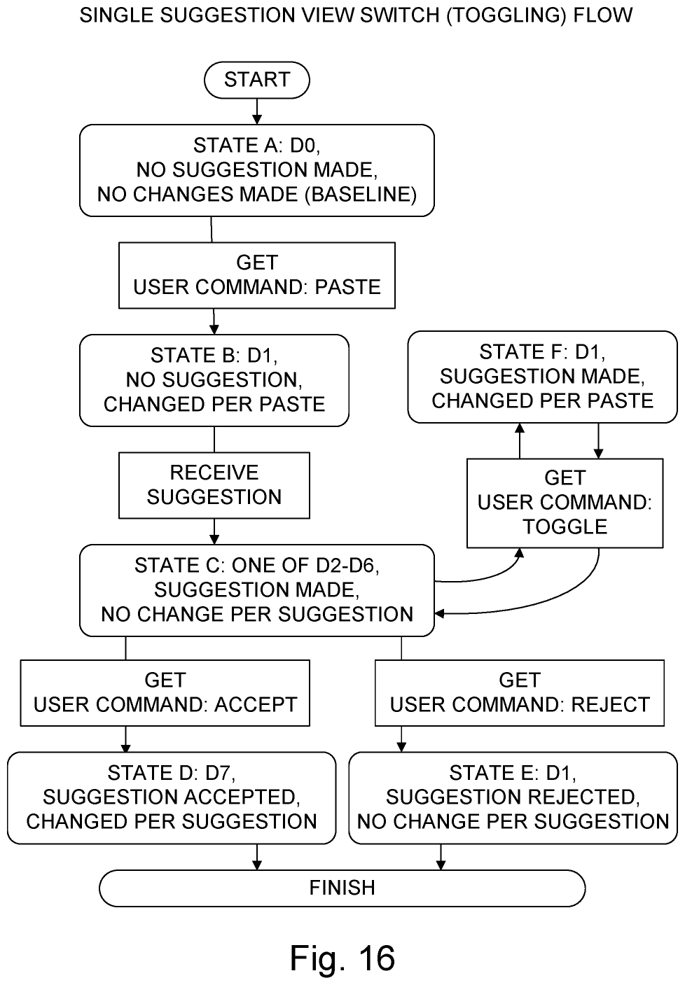

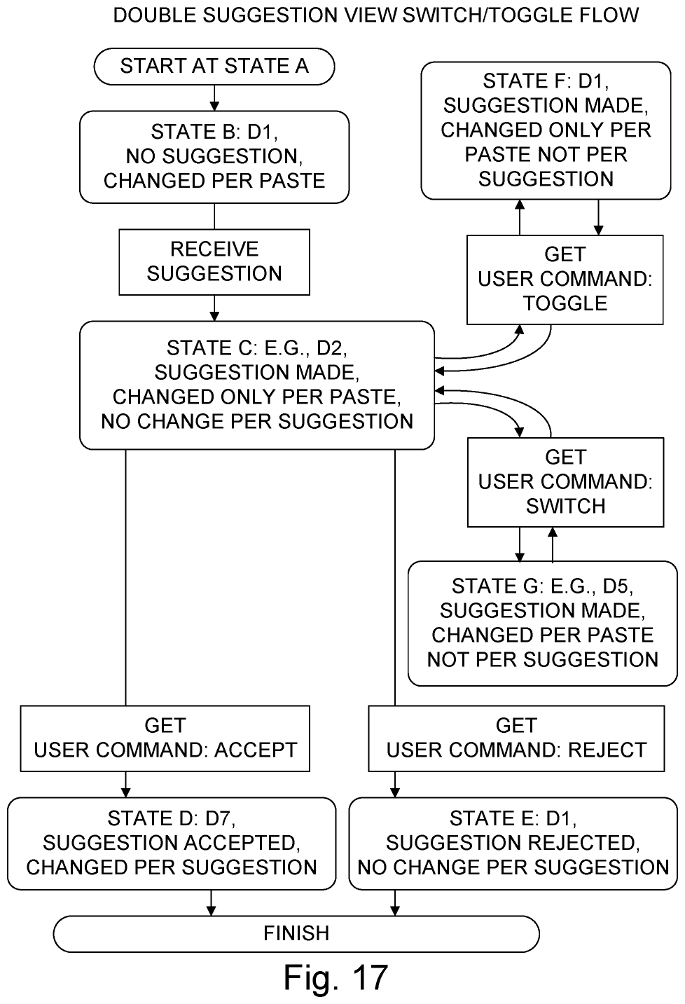

FIGS. 15 to 17 illustrate state machine flows. Some embodiments include an actual state machine, and some otherwise operate in a manner consistent with a state machine flow diagram, e.g., per FIG. 16 or FIG. 17. FIG. 15 is included for context, and to highlight the variety of modes 208 per state C. An embodiment may provide multiple suggestion review modes, and may provide one or more of the individual review modes corresponding to displays D2 through D6.

Each state is a triplet 1500 that answers the three noted questions above about the displayed content, the suggestion status, and the document content. In state A, for instance, the display shows file content prior to the user command 124 that triggers the AI suggestion generation, as in the D0 example. The suggestion has not been made yet by the AI 216, because the suggestion is triggered by a paste 124 that has not yet occurred. The file content is unchanged—no paste, no suggestion acceptance.

Continuing with FIG. 15, after the paste the state machine enters state B. In state B, the display matches D1, the suggestion has not been made yet, and the file content has been changed but only by the paste (not by any suggestion acceptance).

In state C, the suggestion has been made but has not yet been disposed of, e.g., by being accepted or rejected. The suggestion could be displayed to the user in any one of the modes illustrated by D2 through D6.

FIG. 15 shows a basic flow which does not have any toggling or switching between review modes. Instead, at state C the user's only choices are to either accept the suggestion (move to state D) or else reject the suggestion (move to state E).

FIG. 16 shows a flow for an embodiment that allows toggling 504 between what the display looked like before the suggestion 214 and what the display looks like with the pending suggestion. Toggling 504 is an example of switching 504; the term “toggle” indicates switching between two states, whereas switching in general occurs between two or more states. This embodiment provides a UI 206 that facilitates user review of a suggestion 214 by toggling the display 126 between the code block with the suggested changes indicated (state C) and the code block without the suggested changes shown (state F). Such comparison improves human-computer interaction by facilitating fuller review than an approach that hides the pre-suggestion display.

FIG. 17 shows a flow for an embodiment that allows switching 504 between what the display looked like before the suggestion, and two different suggestion review modes, from the group of review modes 208 corresponding to displays D2-D6. Note that a given embodiment may actually implement N of these modes, e.g., only two of them, or only three of them, or only four of them, or all five of them. For example, in one scenario, after the paste the display shows a summary suggestion per D2 (state C) reciting “TAB to conform identifiers with local context, CTRL-TAB for details” and highlighting the pasted text without specifying each particular change that will be made therein. If the user has high confidence in the suggestion, then the user presses TAB and all the suggested changes are made by the system 202 (state D). But if the user wants more detail about the suggested changes, then the user presses CTRL-TAB and the display 126 shows an in-place diff suggestion per D5 (state G). Then the user accepts 306 or rejects 308 the suggestion 214, or the user can switch 504 back to state C to see the summary suggestion which has the original pre-suggestion text.

The foregoing are merely some examples. Consistent with the teachings herein, a given embodiment implements switching 504 between N review modes 208 where N is in the range of two to the total number of modes 208 implemented in the embodiment. Different embodiments of a given group of embodiments implement one or more of the following variations: different ways of visually indicating a review mode 208 (bold, underline, grey text, added or modified graphics, highlighting, color change, layout change, audible alert, pop-up, menu change, etc.), different editing operations 640 performed upon acceptance of a suggestion (insert, delete, replace, copy, move, etc.), different kinds of suggestions 214 (identifier change, refactor, completion, etc.), different user commands 124 that trigger a suggestion (paste, typing, etc.), different command 124 entry implementations such as key bindings or hovering, different change scopes such as all-on-screen or scrolling-required, and different sources 216 of a suggestion. Herein, “grey text” is digital text which is lighter, thinner, smaller, or otherwise less visually prominent than nearby text, despite the name, grey text is not necessarily grey in color.

These embodiment variations may be combined. As a very specific and non-comprehensive example, an embodiment diff mode 208 may show red highlighting of text that will be deleted by a suggested change and show an arrow to a green highlight of text that will be added at a deletion location, with an instruction 624 “Tab to accept” in which “Tab” is shown in a neutral highlight such as gray or brown.

As another specific and non-comprehensive example (all examples herein are individually non-comprehensive, but the point bears repeating), some embodiments allow a developer to change a variable name throughout a function. For example, a developer can press a key combination while hovering over a variable and can then start changing a first instance of the variable inline. All other instances of the variable which are within the syntactic scope of the first instance simultaneously change as the variable is modified. Moreover, the developer is able to toggle between what the code would look like with the changes, and what the code originally was. In one specific embodiment, the tab button is used to toggle between views. In short, these embodiments receive a suggestion that indicates changes to multiple locations in a code block, and provide a UI that toggles on user demand between the code block with the changes and the code block without the changes, thereby facilitating user review prior to acceptance of the suggested changes.

Technical Character

The technical character of embodiments described herein will be apparent to one of ordinary skill in the art, and will also be apparent in several ways to a wide range of attentive readers. Some embodiments address technical activities such as an editing tool 204 receiving 502 AI-generated edit suggestions 214, switching 504 between user interface modes 208, the editing tool 204 performing 608 a sequence of editing operations 640, and tracking 626 usage 628 of user interface modes 208, which are each an activity deeply rooted in computing technology. Some of the technical mechanisms discussed include, e.g., enhanced editing tools 204, state 1500 machines, configurable displays 126, other peripherals 106, tool user interfaces 206, and AI-based editing suggestion 214 generators 216. Some of the technical effects discussed include, e.g., switching 504 on user demand 124 between different user interface modes 208 to facilitate user review of autocreated suggestions 214, and prioritization 630 of a user interface mode 208 based on user activity in a computing system 202. Thus, purely mental processes and activities limited to pen-and-paper are clearly excluded. Other advantages based on the technical characteristics of the teachings will also be apparent to one of skill from the description provided.

Different embodiments provide different technical benefits or other advantages in different circumstances, but one of skill informed by the teachings herein will acknowledge that particular technical advantages will likely follow from particular innovation features or feature combinations, as noted at various points herein.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas, they are not. Rather, the present disclosure is focused on providing appropriately specific embodiments whose technical effects fully or partially solve particular technical problems, such as how to promote user confidence in AI-based editing suggestions 214, and how to facilitate an optimal human review of AI-based editing suggestions 214. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, peripherals, software process flows, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
ID: identification or identity
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Autocreated suggestion review operations such as receiving 502 an autocreated suggestion 214, switching 504 between user interface modes 208, getting 506 user commands 124, displaying 602 autocreated suggestions 214, performing 608 edit operations 640, and many other operations discussed herein, are understood to be inherently digital. A human mind cannot interface directly with a CPU or other processor, or with RAM or other digital storage, to read and write the necessary data to perform the autocreated suggestion review steps 600 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities, it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as accepting, creating, describing, differentiating, dismissing, displaying, disposing, editing, generating, getting, illustrating, operating, performing, prioritizing, receiving, recognizing, rejecting, showing, switching, tracking, undoing, using (and accepts, accepted, creates, created, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102; data structures, values, source code and other software, commands, content, suggestions, and other examples are discussed herein
120 kernel(s), e.g., operating system(s), BIOS, UEFI, device drivers
122 tools and applications, e.g., version control systems, cybersecurity tools, software development tools, office productivity tools, social media tools, diagnostics, editors, browsers, games, email and other communication tools, commands, and so on; services are an example of tools
124 user command; digital
126 display screens, also referred to as “displays”
128 computing hardware not otherwise associated with a reference number 106, 108, 110, 112, 114
130 cloud, also referred to as cloud environment or cloud computing environment
202 enhanced computing system, i.e., system 102 enhanced with autocreated suggestion review functionality as taught herein; e.g., software or specialized hardware which performs or is configured to perform step 506 to get a switch command and then step 504, or any software or hardware which performs or is configured to perform a novel method 600 or a computational autocreated suggestion review activity first disclosed herein
204 editing tool; software or special-purpose hardware or both
206 user interface; software
208 user interface mode; state or set of states or other operational constraint on a user interface
210 document, e.g., file or other digital artifact loaded into an editor 204
212 digital content of a document or a user interface or both
214 autocreated editing suggestion, also referred to as a suggestion, or an AI-generated suggestion, or a recommendation or an AI-generated recommendation, for example; digital
216 suggestion 214 generator; computational
218 machine learning model or an API thereof or both; computational
220 code synthesizer or an API thereof or both; computational
222 code transform or transform generator or an API thereof or both; computational
302 editing result, e.g., change in content 212; digital
304 disposition of a suggestion 214, as represented in a system 202, e.g., a result of disposing 508; computational or digital or both
306 acceptance of a suggestion 214, e.g., a computational activity accepting the suggestion or a result of such acceptance, or both, as represented in a system 202
308 rejection of a suggestion 214, e.g., a computational activity rejecting the suggestion or a result of such rejection, or both, as represented in a system 202
310 dismissal of a suggestion 214, e.g., a computational activity dismissing the suggestion without accepting it or rejecting it, or a result of such dismissal, or both, as represented in a system 202
312 undo generally, and in particular undoing of an accepted suggestion 214, e.g., a computational activity undoing change that resulted from accepting the suggestion or a result of such undoing, or both, as represented in a system 202
314 display aspects, also referred to as display views, as represented in a system 202
316 diff view in a system 202, e.g., a view which distinguishes between additions by a suggestion and deletions by the suggestion
318 in-place view in a system 202, e.g., a view which shows a result of a suggestion's removals and additions superimposed but highlighted
320 as-if view in a system 202, e.g., a view which shows what edited content would look like if a suggestion is accepted, without visual indications of specific changes other than the actual content modifications
402 computer source code, e.g., text in a programming language, text of script, text which can be parsed according to a syntax other than a natural language syntax, markup language text, regular expressions, style sheet specifications, or text which is generated automatically by a code generator
404 source code editor; and example of an editor 204, which is in turn an example of a tool 122
406 integrated development environment, a software development tool 122
408 word processor tool 122
410 computer aided design tool 122
412 graphics editing tool 122
500 flowchart; 500 also refers to autocreated suggestion review methods that are illustrated by or consistent with the FIG. 5 flowchart
502 computationally receive an autocreated suggestion, e.g., via an API or a function call internal to an editor
504 computationally switch from one user interface mode 208 to another user interface mode 208, with a corresponding change in visible content on a display 126
506 computationally get a user command 124, e.g., via an API
508 computationally dispose of a suggestion 214, thereby changing to a system 202 state in which the suggestion is no longer pending
600 flowchart; 600 also refers to autocreated suggestion review methods that are illustrated by or consistent with the FIG. 6 flowchart, which incorporates the FIG. 5 flowchart and other steps taught herein
602 computationally display a suggestion, e.g., by configuring a display 126 with a human-readable depiction of the suggestion or an aspect of the suggestion
604 computationally illustrate a suggestion, e.g., by configuring a display 126 with a view 314
606 computationally differentiate between user interface modes, e.g., by configuring a display 126 differently for different modes 208
608 computationally perform an editing operation 640
610 a sequence of editing operations 640 in a system 202
612 contiguous time period
614 computationally get a suggestion disposal user command 124; an example of step 506;
616 suggestion disposal user command, e.g., a user command whose execution performs a disposal 508
618 computationally avoid switching 504 generally, or a particular category of switching, during a specified time period
620 suggestion review time period
622 computationally show an acceptance command description, e.g., by configuring a display 126
624 acceptance command description in a system 202
626 computationally track usage of two or more modes 208
628 usage of user interface mode 208, e.g., number of switches to the mode, or time spent in the mode, or both, per user or per group of users
630 computationally prioritize a mode 208, e.g., by favoring presentation of that mode rather than another mode
632 computationally recognize an I/O operation
634 mouse operation in a system 202
636 keyboard operation in a system 202
638 any step or item discussed in the present disclosure that has not been assigned some other reference numeral; 638 may thus be shown expressly as a reference numeral for various steps or items or both, and may be added as a reference numeral (in the current disclosure or any subsequent patent application which claims priority to the current disclosure) for various steps or items or both without thereby adding new matter
640 editing operation, e.g., cut, paste, find, replace, or another operation in an editor 204 that changes content 212
642 microphone operation in a system 202
900 suggestion guide, as represented in a system 202
1500 state of a user interface in a system 202

### CONCLUSION

Some embodiments facilitate human review of autocreated editing suggestions 214, e.g., suggestions from a machine learning model 218 or other AI-based generator 216 for editing source code 402. Upon receiving 502 a suggestion, an enhanced editor 204 switches 504 to a user interface review mode 206 which displays 602 an aspect of the suggestion. Suggestions 214 are illustrated 604 using one or more summary (D2), diff (D3, D4, D5), in-place (D5, D6), or as-if (D6) views 314. Upon getting 506 a user command 124, the editor switches 504 back to the pre-suggestion display (D1), or switches 504 to a different view 314 of the suggestion 214, or both. In some scenarios, suggestion review of an initially acceptable but ultimately rejected suggestion 214 follows a review-reject sequence S1 instead of an accept-review-undo sequence S2. In some scenarios, suggestion review visually contrasts pre-suggestion document content 212 (D1) with suggested content 212 (D2-D6), by switching 504 display modes 208 on user demand 124, prior to disposal 508 of the suggestion 214. In some scenarios, user interface review mode usage 628 is tracked 626, and modes 208 are prioritized 630 based on their usage.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured to promote user confidence and trust in AI-based source code editing suggestions by presenting a suggested source code change in multiple modes before any commitment of the suggested source code change, the computing system comprising:
a digital memory and a processor in operable communication with the digital memory;
a source code editing tool having a user interface, the user interface having a set of user interface modes, the source code editing tool configured to perform a sequence of editing operations upon execution by the processor, the sequence comprising: receiving in a first user interface mode of the set of user interface modes an autocreated editing suggestion which specifies the suggested source code change, the autocreated editing suggestion being free of any source indicator which identifies a human as a source of the autocreated editing suggestion, the autocreated editing suggestion not displayed in the first user interface mode, in response to the receiving, switching from the first user interface mode to a second user interface mode of the set of user interface modes which displays the autocreated editing suggestion in a manner consistent with an automatic creation of the autocreated editing suggestion by not displaying any visual indication that a human is a source of the autocreated editing suggestion, in the second user interface mode getting a mode switch user command, and in response to the getting, switching from the second user interface mode to at least one of the first user interface mode or a third user interface mode of the set of user interface modes which displays the autocreated editing suggestion differently than the autocreated editing suggestion is displayed in the second user interface mode;
wherein the user interface modes each differ from one another visually in at least one of: a display of the autocreated editing suggestion, or a display of an editing result that will follow from an acceptance of the autocreated editing suggestion; and
wherein during the sequence the source code editing tool does not do any of: accept the autocreated editing suggestion, reject the autocreated editing suggestion, dismiss the autocreated editing suggestion, or get an undo user command.

2. The computing system of claim 1, wherein the second user interface mode displays at least one of:
a side-by-side diff view illustrating the autocreated editing suggestion;
an over-under diff view illustrating the autocreated editing suggestion;
an in-place diff view illustrating the autocreated editing suggestion; or
an in-place as-if view illustrating the autocreated editing suggestion.

3. The computing system of claim 1, wherein the sequence comprises switching to the third user interface mode in response to getting the mode switch user command.

4. The computing system of claim 1, wherein the source code editing tool comprises or resides within an integrated development environment.

5. An editing method performed by a source code editing tool in a computing system, the method comprising:
receiving, in a first user interface mode of a set of user interface modes, an autocreated editing suggestion which specifies a suggested source code change, without displaying the autocreated editing suggestion in the first user interface mode;
in response to the receiving, switching from the first user interface mode to a second user interface mode of the set of user interface modes which displays the autocreated editing suggestion in a manner consistent with an automatic creation of the autocreated editing suggestion by not displaying any visual indication that a human is a source of the autocreated editing suggestion;
in the second user interface mode, getting a mode switch user command;
in response to the getting, switching from the second user interface mode to at least one of the first user interface mode or a third user interface mode of the set of user interface modes which displays the autocreated editing suggestion differently than the autocreated editing suggestion is displayed in the second user interface mode and without displaying any visual indication that a human is a source of the autocreated editing suggestion;
wherein the user interface modes each differ from one another visually in at least one of: a display of the autocreated editing suggestion, or a display of an editing result that will follow from an acceptance of the autocreated editing suggestion; and
wherein during a contiguous time period that encompasses the switching from the first user interface mode to the second user interface mode, the getting the mode switch user command, and the switching to at least one of the first user interface mode or a third user interface mode, the source code editing tool does not dispose of the autocreated editing suggestion by doing any of: accept the autocreated editing suggestion, reject the autocreated editing suggestion, dismiss the autocreated editing suggestion, or get an undo user command.

6. The method of claim 5, wherein the method comprises, after receiving the autocreated editing suggestion in the first user interface mode and before disposing of the autocreated editing suggestion, switching at least twice to the first user interface mode from at least one other user interface mode in response to getting a respective mode switch user command.

7. The method of claim 5, wherein the method comprises, after receiving the autocreated editing suggestion in the first user interface mode and before disposing of the autocreated editing suggestion, switching between at least three user interface modes in response to getting a respective mode switch user command.

8. The method of claim 5, wherein the second user interface mode displays a diff view illustrating the autocreated editing suggestion.

9. The method of claim 5, wherein the second user interface mode displays an in-place view illustrating the autocreated editing suggestion.

10. The method of claim 5, wherein the second user interface mode displays an as-if view illustrating the autocreated editing suggestion.

11. The method of claim 5, wherein displaying the autocreated editing suggestion comprises showing a human-readable description of a suggestion acceptance user command.

12. The method of claim 5, wherein the method avoids switching to any third user interface mode during a review time period which begins with the contiguous time period and ends with getting a suggestion disposal user command.

13. The method of claim 5, further comprising getting a suggestion disposal user command and in response disposing of the autocreated editing suggestion.

14. The method of claim 5, wherein the second user interface mode displays the autocreated editing suggestion and the autocreated editing suggestion includes a source code refactoring suggestion.

15. The method of claim 5, further comprising tracking respective usage of at least the second user interface mode and the third user interface mode, and prioritizing presentation of user interface modes based at least in part on respective display durations of user interface modes.

16. A computer-readable storage device configured with data and instructions which upon execution by a processor cause a computing system to perform a source code editing method, the method performed by a source code editing tool in a computing system, the method comprising:
receiving, in a first user interface mode of a set of user interface modes, an autocreated editing suggestion which specifies a suggested source code change, without displaying the autocreated editing suggestion in the first user interface mode;
in response to the receiving, switching from the first user interface mode to a second user interface mode of the set of user interface modes which displays the autocreated editing suggestion in a manner consistent with an automatic creation of the autocreated editing suggestion by not displaying any visual indication that a human is a source of the autocreated editing suggestion;
in the second user interface mode, getting a mode switch user command;
in response to the getting, switching from the second user interface mode to another user interface mode of the set of user interface modes which displays the autocreated editing suggestion differently than the autocreated editing suggestion is displayed in the second user interface mode and without displaying any visual indication that a human is a source of the autocreated editing suggestion;
then getting another mode switch user command, and in response to the getting, again switching user interface mode;
wherein the user interface modes each differ from one another visually in at least one of: a display of the autocreated editing suggestion, or a display of an editing result that will follow from an acceptance of the autocreated editing suggestion; and
wherein during a contiguous time period that encompasses each switching and each getting, the source code editing tool does not dispose of the autocreated editing suggestion by doing any of: accept the autocreated editing suggestion, reject the autocreated editing suggestion, dismiss the autocreated editing suggestion, or get an undo user command.

17. The computer-readable storage device of claim 16, wherein getting a mode switch user command comprises recognizing a result of at least one of: a mouse operation, a keyboard operation, or a microphone operation.

18. The computer-readable storage device of claim 16, wherein receiving the autocreated editing suggestion comprises receiving at least one of: a code synthesizer output, a machine learning model output, or a code transform generator output.

19. The computer-readable storage device of claim 16, wherein the method comprises, after receiving the autocreated editing suggestion in the first user interface mode and before disposing of the autocreated editing suggestion, switching at least three times to the first user interface mode from at least one other user interface mode in response to getting a respective mode switch user command.

20. The computer-readable storage device of claim 16, wherein the user interface modes each differ from one another visually in the display of the editing result that will follow from the acceptance of the autocreated editing suggestion.
